(19) United States
(12) Patent Application Publication
(10) Pub. No.: US 2012/0118922 A1
(43) Pub. Date: May 17, 2012

(54) FRAME ASSEMBLY FOR A BACKPACK FOR CARRYING SMALL CHILDREN

(75) Inventors: Stephen BUFFINTON, Augsburg (DE); Miguel Tiblas, Augsburg (DE)

(73) Assignee: Deuter Sport GmbH & Co. KG, Gersthofen (DE)

(21) Appl. No.: 12/983,520

(22) Filed: Jan. 3, 2011

(30) Foreign Application Priority Data
Nov. 11, 2010 (DE) 10 2010 051 137.4

(51) Int. Cl. A47D 13/02; A45F 3/08; F16C 11/04

(52) U.S. Cl. 224/159; 403/119; 403/145

(57) ABSTRACT

There is provided a frame assembly for a backpack for carrying small children and comprising a back frame and a U-shaped support stand. The support stand is connected with the back frame at both ends through an articulated joint each. The articulated joints each comprise two housing members adapted to be placed in relatively angled positions and have to end positions each between which the articulated joints can be flexed. One of said articulated joints has disposed between said end positions resistance means that can be overcome independently from both end positions. The other articulated joint comprises resistance means that can be overcome independently from the first end position but from the second end position by an externally acting force only.

The invention relates to a frame assembly for a backpack for carrying small children and to a backpack comprising such a frame assembly.

DE 40 29 705 A1 discloses an arrangement comprising a frame assembly for a backpack intended especially for carrying infants. The frame assembly comprises a back frame with support structure interconnected for relative pivoting by articulated fittings operable from both sides.

Articulated fittings operable from either side are disadvantageous in that the swinging in and out of the support requires the simultaneous use of both hands to manipulate the fittings on the two sides and to release the support for movement, leaving no hand free to support or hold the backpack itself. Backpacks of this kind may be intended for small children up to about 20 kgs. weight; if the small child is somewhat older, supporting and holding the backpack calls for some skill or the assistance of a second person to get the backpack to assume its upright position. In the handling of backpacks of this kind, there is some likelihood of the children carried in them sustaining injuries.

Against this background, it is the object underlying the invention is to provide a frame assembly which is relatively simple in structure, avoids the aforesaid drawbacks and is simple to operate.

This object is accomplished by the features recited in the main claim, advantageous further developments and embodiments of the invention being recited in the dependent claims.

The above object is accomplished in a frame assembly for a backpack for carrying small children which comprises a back frame and a support stand. The support stand is connected with the back frame through articulated joints at both ends of the former. The articulated joints each comprise two housing members adapted to be placed in angled relative positions and having two end positions between which they can be flexed. One such articulated joint comprises between the two end positions means exerting a resistance that can be overcome from both end positions independently; the other joint comprises means exerting a resistance that can be overcome independently from the first end position while it can be overcome from the second end position by an externally acting force only.

A preferred embodiment of the frame assembly is characterized by the resistance means of one joint being formed by a ramp element slanted on both sides. The invention is not limited to a single ramp element. Rather, the resistance may be formed by a plurality of similarly configured ramp elements to be overcome simultaneously.

A preferred embodiment of the frame assembly is characterized by the resistance of the other joint being formed by a ramp element slanted on one side. The ramp element preferably has on one side a slanted ramp and on the other side a steep flank not susceptible to be overcome independently. The invention is not limited to a single ramp element. The resistance may be formed by a plurality of similarly configured ramp elements to be overcome simultaneously.

Another preferred embodiment of the frame assembly is characterized by the resistance means to be overcome being located in a housing member of each joint.

A preferred embodiment of the frame assembly is characterized by the joint housing members comprising a recess receiving a movable latching element.

The latching element preferably is fixed against rotation relative to said one housing member and is rotatable relative to the other joint housing member.

The latching element is preferably biased by spring means towards the recess of the opposite housing member. Such spring means may be a spiral spring, for example.

The other articulated joint preferably is designed so that the external force applied to overcome the resistance of the other joint acts upon the latching element in a direction opposite to the tension of the spring means.

The other articulated joint is preferably provided with a pressure element adapted to exert a force on the latching element of that joint.

The pressure element is preferably located on the housing element of the other articulated joint connected with the support stand of the frame assembly.

A preferred embodiment of the frame assembly is characterized by the housing members being provided with means by which each can be coupled with portions of the frame assembly.

Another preferred embodiment of the frame assembly is characterized by the support stand maintaining the backpack in its swung-out condition in an upright stable position when it stands on the floor.

A preferred embodiment of the frame assembly is characterized by the support stand moving substantially independently into its swung-in position after the resistance has been overcome. The resistance is preferably designed in such a manner that the support stand attains its swung-in position independently after the resistance has been overcome, but requires an externally applied force to move from the swung-in into the swung-out position. An advantage of this design is that the support stand cannot swing out accidentally while the frame assembly is being transported.

A particularly preferred embodiment of the frame assembly is characterized by the support stand being in the form of a U-shaped open loop of which the free ends are preferably connected each with the back frame by an articulated joint.

Further, there is provided a backpack for carrying small children, said backpack comprising at least one packing space and a seat for receiving a small child and an inventive frame assembly as described hereinabove.

Further advantages, features and details of the invention are explained and illustrated in the following description, which describes an embodiment example in detail under reference to the drawing.

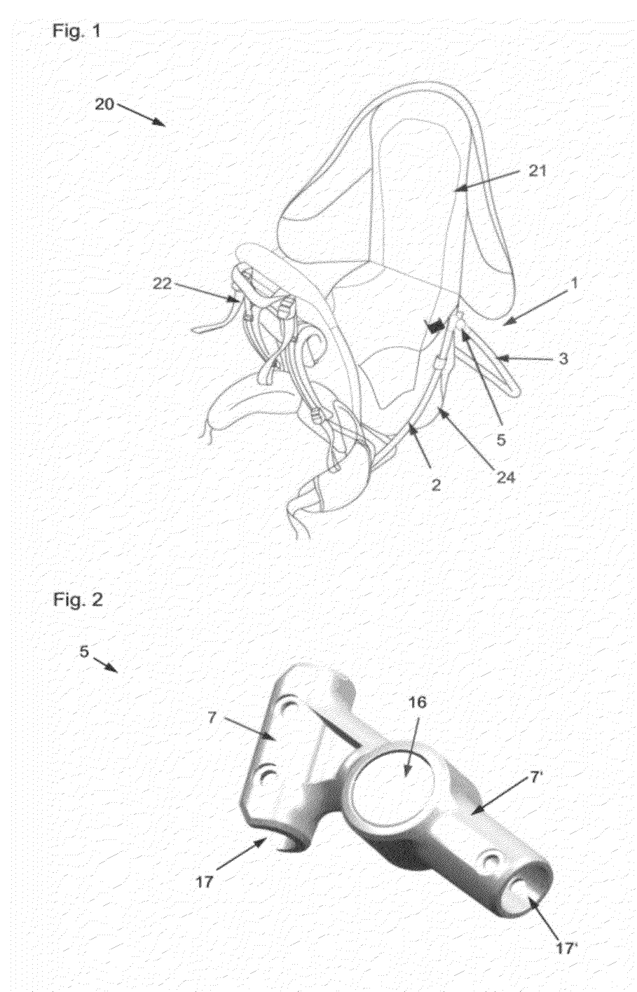

FIG. 1 shows a backpack comprising an embodiment of the inventive frame assembly;

FIG. 2 shows a 3-dimensional view of an articulated joint;

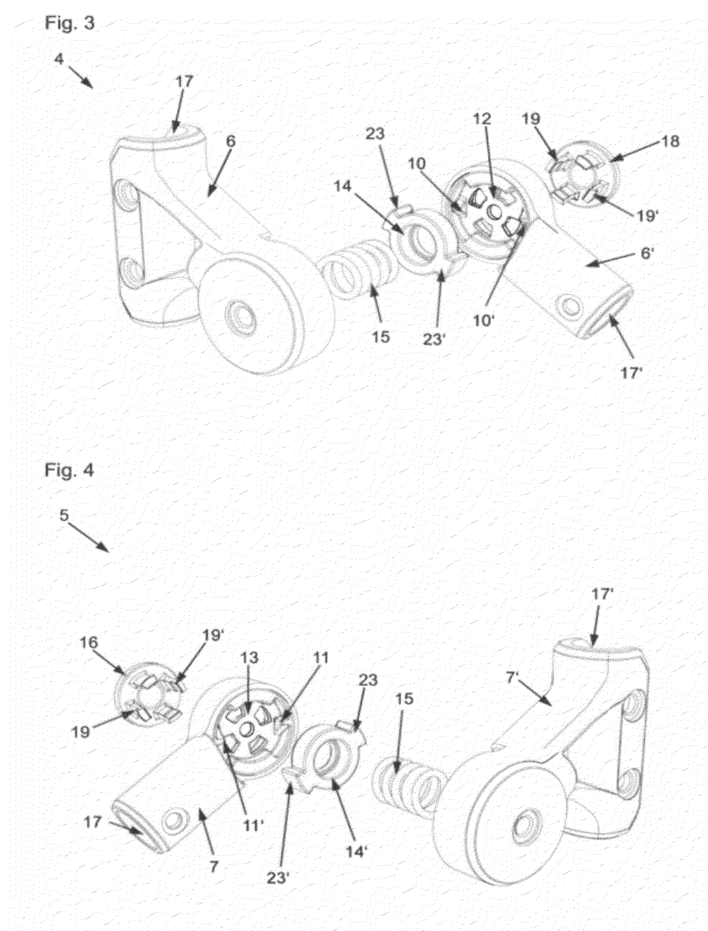

FIG. 3 shows an exploded view of the structure of an articulated joint;

FIG. 4 shows an exploded view of the structure of another articulated joint; and

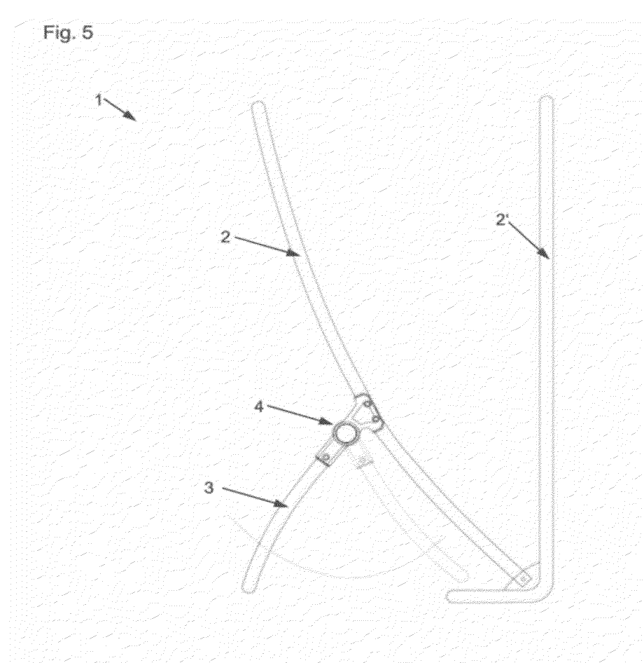

FIG. 5 shows an embodiment of an inventive frame assembly.

FIG. 1 shows a backpack 20 comprising an embodiment of the inventive frame assembly 1. Backpack 20 comprises a seat 21 for carrying a small child. Seat 21 is located on top of a packing space 24. Backpack 20 is adapted to be carried on the user's back via carrying means. Frame assembly 1 of backpack 20 is coupled with support stand 3 approximately at mid-height through an articulated joint 5. In the embodiment shown, support stand 3 is a U-shaped open loop the free ends of which are each coupled with the frame assembly by an articulated joint. FIG. 1 shows part only of frame assembly 1, the remaining portions of frame assembly 1 and the additional joint being hidden by seat 21 of backpack 20. Support stand 3 is shown in its swung-out condition. In its swung-in condition, support stand 3 lies substantially in parallel with back frame 2. Back frame 2 is formed by a plurality of interconnected lengths of tubing which support backpack 20 together with its packing space 24 and seat 21.

A three-dimensional view of an articulated joint 5 is shown in FIG. 2. Articulated joint 5 comprises two housing members 7, 7′ adapted to be positioned at an angle relative to each other. Both housing members 7, 7′ each comprise means 17, 17′ by which they may be coupled with back frame 2 and support stand 3, respectively, of the frame assembly. In the embodiment shown, means 17 of one housing member 7 has the form of a semi-tubular or half-sleeve member, with the half-sleeve member coupled with back frame 2 by way of a riveted or screw connection. In the embodiment shown, means 17′ of other housing member 7′ has the form of a closed tubular or sleeve member adapted to be placed over one end of the support stand. Having been placed this way, the sleeve may be connected with the support stand by way of a riveted or screw connection, for example.

In the embodiment shown of articulated joint 5, the angle included by housing members 7, 7′ is shown to be maximum. In that example, the portions of frame assembly 1 which may be connected by means 17, 17′ include an angle of about 60°. In the swung-in condition, the connectable portions of frame assembly 1 extend substantially in parallel with each other. The two conditions apply to the end positions of joint 5 between which housing members 7, 7′ may be angled relative to each other.

The pivoting range of housing members 7, 7′ is not limited to angles of the aforesaid magnitude. In another embodiment of the frame assembly, it is possible for the articulated joints to comprise a resistance which may be overcome by applying a force to both joints, so that, as shown in FIG. 1, support stand 3 may be folded upwards beyond the standing position.

FIG. 3 shows an exploded view of the construction of an articulated joint 4. Articulated joint 4 comprises a pair of housing members 6, 6′. Housing members 6, 6′ each comprise the aforesaid means 17, 17′ through which housing members 6, 6′ may be coupled with portions of frame assembly 1. In so doing, one housing member 6 preferably is coupled with backframe 2 and the other housing member 6′ with the support stand. Said other housing member 6′ has a recess 12 therein to rotatably receive a latching element 14 shaped to rotate between two positions inside recess 12. Between these two position there is provided a resistance in the form of a ramp element 10. In the embodiment shown, two ramp elements 10 are provided and spaced at a 180° angle. The arrangement of ramps 10, 10′ follows from the external contours of latching element 14. The external contours of latching element 14 are not limited to those shown in FIGS. 3 and 4. It is preferred, however, for the external contours of latching element 14 to comprise at least one outwardly arched protruding portion 23 to co-operate with a resistance in the form of a ramp element 10. In second housing member 6, latching member 14 is mounted to be stationary so that latching element 14 rotates along as that housing member 6 is rotated. To this end, housing member 6 comprises means through which arched protrusions 23, 23′ of latching element 14 are guided in a direction normal to the sense of rotation of housing member 6, 6′.

Latching element 14 is urged by the tension of a spring member 15 towards recess 12 of housing member 6′. In the embodiment shown, spring element 15 has the form of a spiral spring. Because of the tension of spring element 15, ramps 10, 10′ exert a resistance which has to be overcome as housing members 6, 6′ are rotated relative to each other. In the embodiment shown, ramps 10, 10′ are slanted in the direction of rotation on both sides. The slant on both sides of ramps 10, 10′ allows them to be overcome independently when housing members 6, 6′ are rotated relative to each other. In the case of this articulated joint 5, no force needs to be applied externally to be sure that latching element 14 is lifted over ramp elements 10, 10′.

On its outside, housing member 6′ is preferably provided with a cover 18. In the embodiment of articulated joint 4 shown in FIG. 4, cover 18 has projections 19, 19′. Pressure acting on cover 18 will results in a force being exerted onto latching element 14 via projections 19, 19′ which is sufficient for latching element 14 to be lifted over ramps 10, 10′. It is possible this way to place housing member 6, 6′ into relative positions at angles beyond the intended angular range. It is sufficient for this articulated joint 4, however, to provide housing member 6′ with a cover 18 which itself has no function.

FIG. 4 shows an exploded view of the other articulated joint 5. In contrast to articulated joint 4 shown in FIG. 3, articulated joint 5 has in recess 13 of housing member 7′ a resistance formed by ramps 11, 11′ shaped to be independently overcome by latching element 14′ from one side only. Ramps 11, 11′ are slanted to one side; on the other side they have a steep flank which latching element 14′ cannot overcome unless a force is applied externally. In this case, that force acting on latching element 14′ is provided by a pressure element 16. Pressure element 16 has projections 19, 19′ which lift latching element 14′ against the tension of spring means 15′ over the steep flank of ramps 11, 11′. This will overcome their resistance so that housing members 7, 7′ of articulated joint 5 may be rotated relative to each other. Articulated joint 5 is preferably designed so that latching element 14′ may independently overcome ramps 11, 11′ when support stand 3 of frame assembly 1 is to be swung out to assume its standing position. When support stand 3 is to be swung in, a force must be applied to latching element 14′ via pressure element to allow the steep flanks of ramps 11, 11′ to be overcome, ensuring that support loop 3 cannot swing in but is retained in its swung-out position. Also, further movement of the support stand beyond the swung-out standing position will not be possible independently.

FIG. 5 shows a side view of an embodiment of the inventive frame assembly 1. Frame assembly 1 comprises a back frame 2, 2′ forming a supporting frame to which a backpack—preferably for carrying small children—may be attached. Portion 2′ of back frame 2, 2′ forms the part of frame assembly 1 which is turned towards and engages the bearer's back. Portion 2 of back frame 2, 2′ arches upwards to define together with portion 2′ the area where the child will be seated later on. Portion 2 of back frame 2, 2′ is provided with a support stand 3 adapted to be swung inwards. Support stand 3 is connected by an articulated joint 4 with back frame 2 of frame assembly 1. In FIG. 5, support stand 3 is shown in the swung-out and swung-in conditions. In the swung-in condition, support stand 3 lies as close as possible against portion 2 of back frame 2, 2′. A low force is needed to swing support stand 3 out. Articulated joint 5 snaps into and is retained in position in the swung-out condition of support loop 3, and it takes pressure exerted on the pressure element on joint 4 to move support stand 3 from the swung-out into the swung-in position. Articulated joint 4 corresponds to the articulated joint 5 shown in FIG. 4.

As shown in FIG. 1, backpack frame assembly 1 comprises a support stand 3 coupled with back frame 2 on one side by an articulated joint 4 as shown in FIG. 3 and on the other side by an articulated joint 5 as shown in FIG. 4. Thus support stand 3 can be swung out and in by one hand only. A major advantage of this feature is that a second hand may be used for holding the backpack, whereby the safety of handling the backpack is enhanced.

### LIST OF REFERENCE CHARACTERS

1 frame assembly
2, 2′ back frame
3 support stand
4 articulated joint
5 articulated joint
6, 6′ housing member
7, 7′ housing member
8 resistance
9 resistance
10, 10′ ramp
11, 11′ ramp
12 recess
13 recess
14, 14′ latching element
15, 15′ spring element
16 pressure element
17, 17′ means
18 cover
19, 19′ projection
20 backpack
21 seat
22 carrying arrangement
23, 23′ outwardly arched protrusion
24 packing space

1. Frame assembly for a back pack for carrying small children, comprising
a back frame (2) and a support stand (3) connected with back frame (2) through an articulated joint (4, 5) at each end;
with articulated joints (4, 5) each comprising two housing members (6, 6′, 7, 7′) adapted to be placed in angled relative positions, said articulated joints (4, 5) each having two end position between which they can assume such angled positions, with one of said articulated joints (4) having associated therewith a resistance (8) disposed between these two end positions and susceptible to be overcome from both end positions while the other articulated joint (5) has associated therewith a resistance (9) which can be overcome independently from said first end position and can be overcome from the second end position by an externally acting force only.

2. Frame assembly as in claim 1 in which resistance (8) of one of said articulated joints (4) is formed by a ramp element (10) slanted on both sides.

3. Frame assembly as in any one of the preceding claims in which resistance (9) of the other one of said articulated joints (5) is formed by a ramp element (11) slanted on one side.

4. Frame assembly as in any one of the preceding claims, in which resistance (8, 9) to be overcome are disposed each in a housing member (6′, 7′) of articulated joints (4, 5).

5. Frame assembly as in any one of the preceding claims, in which housing members (6, 6′, 7, 7′) of articulated joints (4, 5) each have therein a recess (12, 13) which receives a movable latching element (14, 14′).

6. Frame assembly as in claim 5, in which latching element (14, 14′) is fixed against rotation relative to one housing member (6, 7) and is movable relative to the other housing member (6′, 7′).

7. Frame assembly as in claim 5 or 6, in which latching element (14, 14′) is biased by spring means (15, 15′) towards recess (12, 13) of said second housing member (6′, 7′).

8. Frame assembly as in claim 7 in which the other articulated joint (5) is designed so that, for overcoming resistance (9) of articulated joint (5), said externally acting force acts upon latching element (13) against the tension of spring means (13′).

9. Frame assembly as in claim 8 in which articulated joint (5) comprises a pressure element (16) through which a force can be exerted upon latching element (13) of said other articulated joint (5).

10. Frame assembly as in claim 9 in which pressure element (16) is provided on housing member (7′) of articulated joint (5) which is connected with support stand (3) of frame assembly (1).

11. Frame assembly as in any one of the preceding claims in which housing members (6, 6′, 7, 7′) each comprise means by which said members can be connected with portions of frame assembly (1).

12. Frame assembly as in any one of the preceding claims in which support stand (3) in its swung-out position maintains the backpack in a stable upright position when set down on a floor.

13. Frame assembly as in any one of the preceding claims in which support stand (3) moves substantially independently into its swung-in position after resistance (8, 9) has been overcome.

14. Frame assembly as in any one of the preceding claims in which support stand (3) is in the form of a U-shaped open loop of which the free ends are each connected with back frame (2) by an articulated joint (4, 5).

15. Backpack for carrying small children and comprising at least one packing space (24), a seat (21) accommodating a small child, and a frame assembly as in any one of the preceding claims.
